(19) United States
(12) Patent Application Publication
(10) Pub. No.: US 2022/0407078 A1
(43) Pub. Date: Dec. 22, 2022

(54) LITHIUM METAL BATTERIES HAVING ANODE-FREE CURRENT COLLECTORS

(71) Applicants: CARNEGIE MELLON UNIVERSITY, Pittsburgh, PA (US); MASSACHUSETTS INSTITUTE OF TECHNOLOGY, Cambridge, MA (US)

(72) Inventors: Venkatasubramanian VISWANATHAN, Pittsburgh, PA (US); Vikram PANDE, Pittsburgh, PA (US); Yet-Ming CHIANG, Pittsburgh, PA (US)

(21) Appl. No.: 17/635,987

(22) PCT Filed: Aug. 19, 2020
(86) PCT No.: PCT/US2020/046950

§ 371 Date: Feb. 16, 2022

Related U.S. Application Data
(60) Provisional application No. 62/922,648, filed on Aug. 20, 2019.

(51) Int. Cl. H01M 4/66; H01M 4/04

(52) U.S. Cl. CPC H01M 4/662; H01M 4/0407

(57) ABSTRACT

The invention comprises an anode-free lithium metal cell having an anode-side current collector composed of lithium, a lithium alloy or lithium-containing compound or a transition metal having a lithium or lithium alloy or lithium-containing compound surface coating, to provide a specific energy of the cell of 350 Wh/kg or greater.

### RELATED APPLICATIONS

This application claims the benefit of U.S. Provisional Patent Application No. 62/922,648, filed Aug. 20, 2019, the contents of which are incorporated herein in their entirety.

### GOVERNMENT RIGHTS

This invention was made with Government support under contract DE-EE0007810 awarded by the Assistant Secretary for Energy Efficiency and Renewable Energy, Office of Vehicle Technologies of the US Department of Energy (DOE) through the Advanced Battery Materials Research (BMR) Program. The Government has certain rights in this invention.

### BACKGROUND OF THE INVENTION

Lithium batteries are widely used in various industries due to their high energy density. Lithium metal cells are central to attaining energy density storage to enable electrification of transportation and aviation. Most lithium metal cells use a lithium foil at the anode, as shown in the prior-art battery shown in FIG. 1(A). Given the cathodes are already pre-lithiated, this excess lithium results in a lower energy density than the theoretical limit but improves cycle life by increasing lithium inventory.

In typical prior art batteries, the cathode may be composed of fully-lithiated cobalt, nickel and/or manganese in a crystal structure, forming a multi-metal oxide. Alternatively, a lithium ion phosphate may be used as the cathode. The cathode current collector is typically composed of aluminum. The electrolyte is typically an organic liquid electrolyte, while the separator is typically a polymer such as polypropylene.

Anode-free cells are a limiting case of lithium metal cells involving no excess lithium and thus, the highest possible energy density. Anode-free cells comprise a fully-lithiated cathode stacked with a separator and current collector as shown in FIGS. 1(B-C). During the first charge, the lithium stored in the cathode is deposited on the current collector as metallic lithium and then intercalated in the cathode at subsequent discharge. Anode-free cells are easy and safe to construct as they avoid handling and manufacturing of lithium metal foils. In addition, high-quality thin lithium foils are expensive and one of the major economic risks associated with practical lithium metal batteries. An anode-free design circumvents this issue and, as such, can enable both easily manufacturable and cost-competitive lithium metal batteries.

Lithium metal cells using liquid electrolytes are limited by low coulombic efficiency and dendrite growth. These problems are significantly magnified in anode free cells due to a lack of excess lithium. The large volume expansion of the plated lithium during cycling in anode-free cells leads to a large stress on the solid electrolyte interphase (SEI) resulting in cracking and thus exposing more lithium to the electrolyte for further parasitic reactions. Another important difference in anode-free cells is that the lithium nucleation occurs on the current collector surface, which is significantly different from nucleation on lithium itself. This can lead to nucleation overpotential losses and also affect lithium deposition morphology resulting in dendrite formation.

Modifications to the copper current collector surface have shown improvement in coulombic efficiency and compact lithium deposition. A variety of coatings, such as transition metals and carbon/graphene on copper, have also been used to modify the lithium nucleation and, in turn, the morphology. The lithium nuclei size, shape and areal density are dependent on the applied current density. In general, larger current density results in a larger number of nuclei with smaller sizes. This will result in increased surface area and increased SEI formation and poor coulombic efficiency. Thus, in addition to identifying electrolytes that can lead to high performing SEIs, designing the current collector surface becomes a key issue for anode-free batteries.

It would be desirable to have batteries having specific energies greater than 350 Wh/kg in an anode-free configuration. However, the difficulties discussed above with prior art design make achieving this difficult.

### SUMMARY OF THE INVENTION

The invention described herein addresses the limitations associated with anode-free lithium metal cells and is directed to batteries having improved anode-free configured lithium-metal configurations and being able to achieve specific energies near to or greater than 350 Wh/kg. The invention pertains to batteries using lithium-based alloys as the current collector material to improve lithium deposition and increase specific energy to a level higher than is available in prior-art anode-free batteries. By improving nucleation and diffusion, the batteries of the present invention described herein can lead to the reduction of dendritic morphology, resulting in an improved cycle life at higher charging currents.

Also disclosed herein are the results of a study of lithium nucleation on a variety of candidate current collectors using density functional theory calculations. Using a thermodynamic analysis based on the density functional theory calculations, the thermodynamic nucleation potential and Li surface diffusion activation energies of various materials was determined. Li alloys are much better candidates as current collectors compared to the transition metals as they have very good Li nucleation and Li surface diffusion. There is a correlation between Li adsorption energy and Li diffusion activation energy. This relationship clearly shows that the best performing current collector surfaces should possess Li adsorption energy close to zero. Therefore, the present invention pertains to anode-free batteries using the best performing surfaces as current collectors.

### BRIEF DESCRIPTION OF THE DRAWINGS

FIG. 1(A) shows a standard prior art lithium metal battery configuration. FIG. 1(B-C) show two configurations of anode-free batteries wherein (B) employs a new current collector material and (C) employs a new coating material on a standard current collector such as Cu, Ti, etc.

FIG. 2 is a graph showing the specific energies of various anode-free cells using 10 μm current collectors made of different transition metals and lithium alloys

FIG. 3 is a graph showing lithium adsorption energies at low coverage.

FIG. 4 is a graph showing lithium adsorption energies at 1 mL coverage on transition metals not forming an ally with lithium.

FIG. 5 is a graph showing lithium surface diffusion activation energies on transition metals.

FIG. 6 shows table S1, showing a list of surface energies for transition metals that do not alloy with lithium.

FIG. 7 shows Table S2, showing a list of surface energies for different Li alloy surfaces.

FIG. 8 is a graph showing lithium absorption energies at low coverage.

FIG. 9 is a graph showing lithium absorption energies at 1 mL coverage on lithium alloys.

FIG. 10 is a graph showing lithium surface diffusion activation energies on lithium alloys

FIG. 11 is a graph showing the BEP relation between adsorption enthalpy for nucleation for 1 mL lithium coverage and the activation energy for 12 different structures.

FIG. 12 is a graph showing a volcano relationship for the performance of current collectors based on a single descriptor of 1 mL lithium absorption energy, showing lithium absorption energies and lithium surface diffusion activation energies for all materials considered herein. The shaded region is where the nucleation overpotential and activation energy is at least as good as on lithium itself.

### DETAILED DESCRIPTION

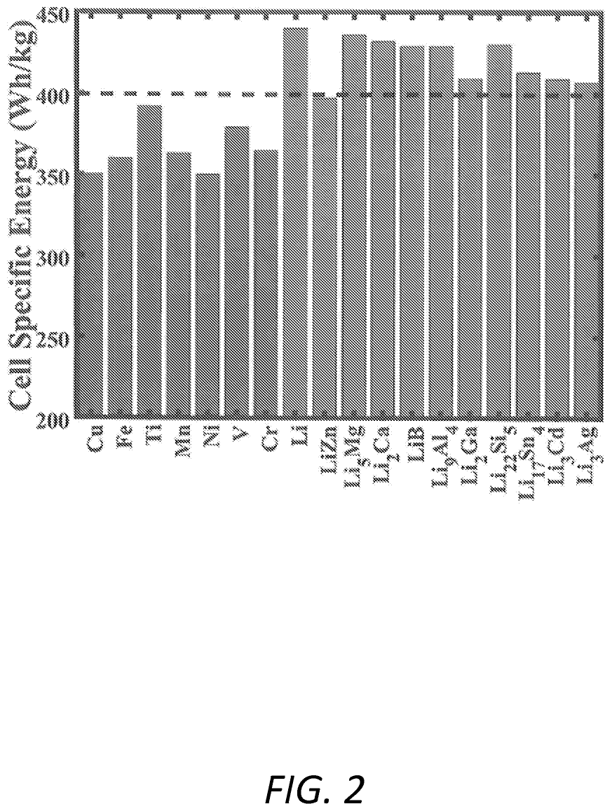

There are two possible approaches for an anode-free design: (i) replace copper as current collector completely or (ii) apply a coating of material on top of copper. As shown in FIG. 2, the first approach of replacing copper as the current collector will lead to additional benefit of increasing the energy density. This is largely attributed to the high density of Cu (8.96 g/cc) compared to the proposed candidates and lithium (0.5 g/cc). Specifically, an anode-free configuration with Li-alloys will allow a specific energy greater than 400 Wh/kg compared to 350 Wh/kg with Cu. Use of coatings will not affect the specific energy as Cu is still used.

The invention thus focuses on the use of other current collector candidates that out-perform Cu. A material must possess the following necessary properties, in addition to others, for use as a current collector in anode free batteries: (a) High electronic conductivity; (b) stable against corrosion; (c) Li nucleation potential leading to 2D growth; and (d) fast surface diffusion of Li on the surface.

In some embodiments of the invention described herein, lithium or a lithium-alloy is used as a current collector to develop cells with specific energy greater than, but not limited to, about 400 Wh/kg. In some embodiments, the invention described herein includes the use of binary and ternary lithium alloys, including, but not limited to, lithium-zinc, lithium-aluminum, lithium-boron, lithium-cadmium, lithium-silver, lithium-silicon, lithium-lead, lithium-tin, lithium-germanium, lithium-selenium, lithium-tellurium, lithium-arsenic, lithium-antimony, lithium-bismuth, lithium-thallium, lithium-indium, lithium-gallium, and lithium magnesium as current collectors for anode-free batteries, which can lead to high specific energies, low nucleation overpotentials, better rate capability and better control over dendrite in electrolytes. In other embodiments, Li-alloys comprising any number of different elements may be used.

The high electronic conductivity constraint restricts possible materials to metals and Li-alloys. When cost and abundance are also considered, the list of materials narrows down to Na, K, Cu, Fe, Ti, Ni, Cr, V, Mo, W, Zr, Mn as the transition metal elements and Li—Zn, Li—Al, Li—Ga, Li—B, Li—Si, Li—Sn, Li—Pb, Li—Cd, Li—Mg, Li—Ca, Li—Sr, Li—Se, Li—Te, Li—Tl, Li—In, Li—Bi, Li—Sb, Li—Ge, Li—As and Li—Ag. During operation of anode-free batteries, the anode potential will likely be ˜0 V on the Li/Li+ scale. The redox potentials of Ca, Sr and K is close to the anode potential, implying that they may dissolve under these conditions. Na and Mg are highly reactive chemically and thus were not considered.

For the alloy materials, only the fully lithiated phases were considered as any other phase would consume lithium inventory during cycling. In some embodiments, partially lithiated phases can also be used as long as it satisfies the adsorption characteristics and kinetic barriers identified. Thus, the final list of materials considered is Cu, Fe, Ti, Ni, Cr. V, Mo, W, Zr, Mn, LiZn, Li₉Al₄, Li₂Ga, LiB, Li₂₂Si₅, Li₁₇Sn₄, Li₂₂Pb₅, Li₃Cd, Li₂Se, Li₂Te, Li₁₃In₃, Li₃Tl. Li₁₅Ge₄, Li₃Sb, Li₃As, Li₃Bi and Li₃Ag. Density functional theory (DFT) calculations were performed on the low miller index surfaces of all of these materials to evaluate the Li nucleation overpotential and Li surface diffusion energy barrier.

Self-Consistent DFT calculations were performed using the real space projector-augmented wave method implemented in the GPAW code. The Bayesian Error Estimation Functional with van der Waals (BEEF-vdW) exchange correlation functional was used for all adsorption free energy calculations owing to its accuracy for describing adsorption energies and energy barriers. For all calculations, the two bottom layers of the unit cell were constrained and the top two layers along with the adsorbates were allowed to relax with a force criterion of <0.05 eV/A°. A Fermi smearing of 0.1 eV was used. The Brillouin zone was sampled using the Monkhorst Pack scheme and a k-point grid was chosen such that the kₓLₓ, k_{y}L_{y}, k_{z}L_{z}>40° A⁻¹ where kₓ, k_{y}, k_{z} are the number of k-points and Lₓ, L_{y}, L_{z} are the lengths of the unit cell in the x, y, z directions. To evaluate the nucleation overpotentials, a low coverage (θ<0.2) and the fully (1 ML) covered (θ=1) surfaces were simulated.

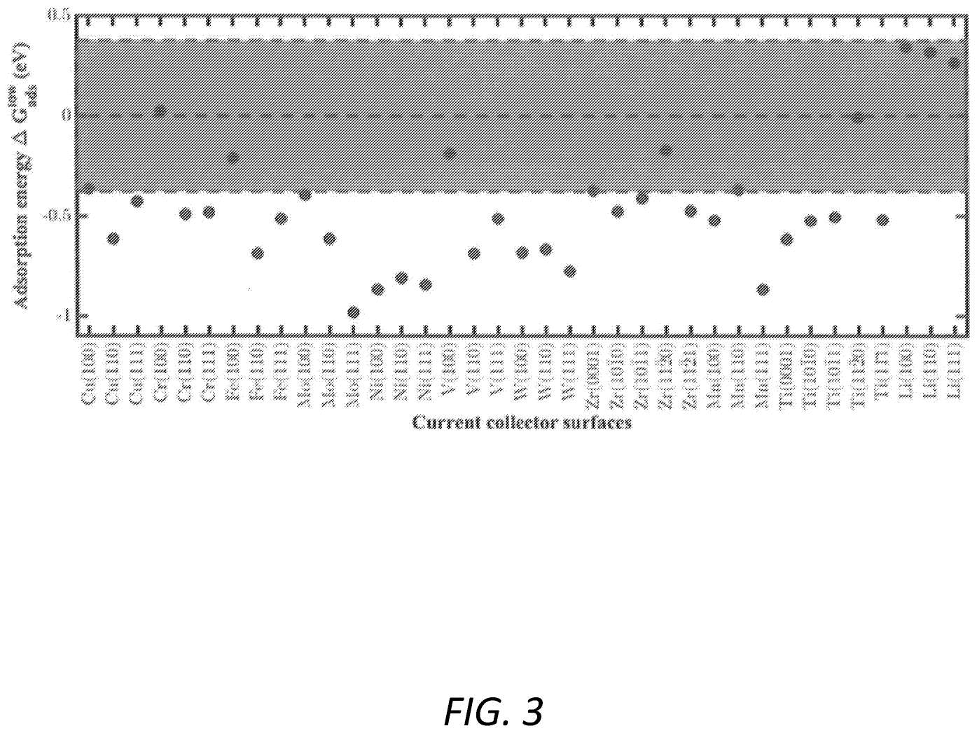

At low Li coverage, the Li nucleation overpotential on Li itself is about 0.3 V, while, at 1 ML coverage, it drops down to 0.1 V. Most transition metals bind Li too strongly with an overpotential >0.3 V at low coverage as shown in FIG. 3.

Cr(100), Fe(100), V(100), Zr(1120), Ti(1120) and Mn(110) adsorb Li at low coverage with lower nucleation overpotential than Li itself. For Cr, Fe and V, which are bcc crystals, the Li is adsorbed in the hollow site and the (100) surface has the weakest binding due to a higher coordination number of the surface atoms.

Similarly, for hcp metals Zr and Ti, the weakest binding is for the (1120) surface and for Mn it is the (110) surface.

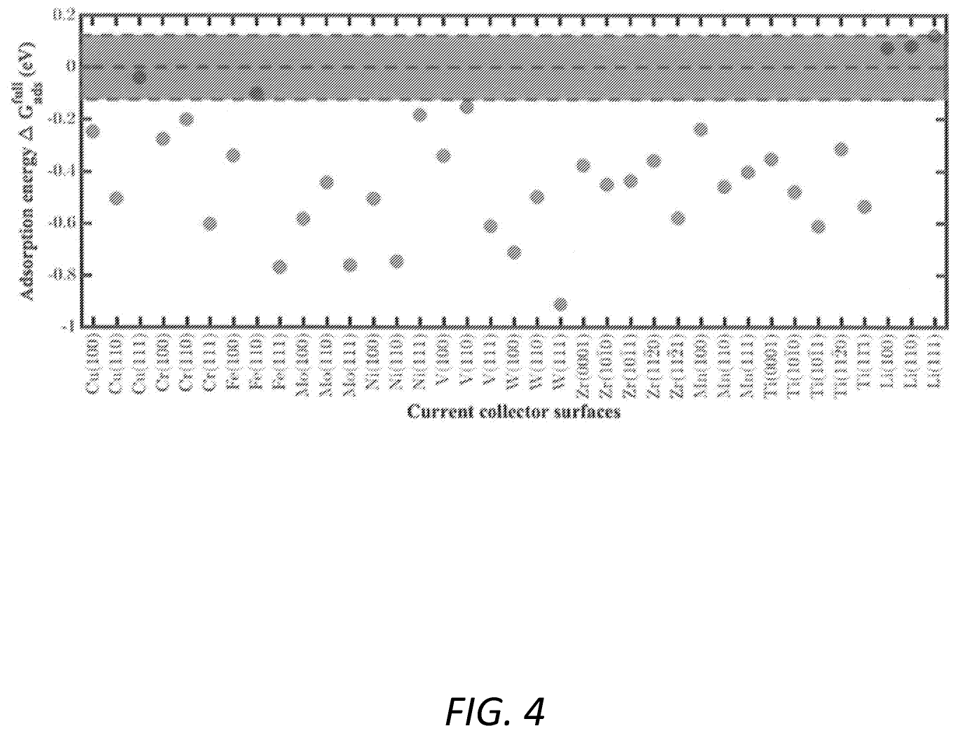

At 1 ML Li coverage, almost all transition metal surfaces significantly over-bind Li, with the exception of Cu(111), Fe(110), V(110) and Ni(111) as shown in FIG. 4. For the fee metals such as Cu and Ni, the Li atoms adsorb weaker on the (111) surface compared to the (100) and (110) surfaces. This is because the Li coordination is 3 for the (111) surface and 4 for the (100) and (110) surfaces. For the bcc metals, such as Fe, Cr, Mo, etc. Li atoms adsorb the weakest on the (110) surface due to lower coordination. Lastly for the hcp crystals such as Zr and Ti, the (1120) surface has the weakest Li adsorption. Cu(111) has an exceptionally low nucleation at 1 ML coverage probably because of low coordination and similar lattice constants of Cu and Li.

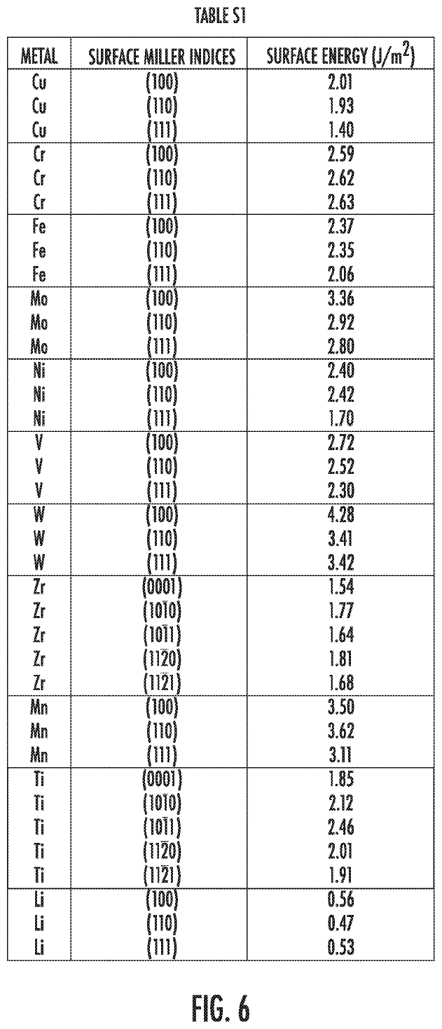

The surface energies given in Table S1 (See FIG. 6, showing a list of surface energies for transition metals that do not alloy with Li) show that all low index surfaces of Li have very similar surface energies. Thus, the nucleation overpotential is governed by the best of the three surfaces and would be around 0.26 V for low coverage of Li and 0.07 V for 1 ML covered Li surface. For Cu, the (111) surface has the lowest surface energy and has very low 1 ML coverage overpotential but significantly high low coverage nucleation overpotential. Thus, increasing the fraction of the (111) surface on the surface can reduce the overpotential. The (111) surface is the most stable surface for Fe but the (110) surface has a very good Li nucleation at 1 ML coverage. Fe could potentially be used by increasing the fraction of the (110) surface but this would be challenging due to thermodynamic stability. Similarly, for V, the (111) surface is the most stable, but the (100) and (110) surfaces have better Li adsorption characteristics.

For Ni, the (111) surface is the most stable and has moderate binding at 1 ML coverage but over binds Li at low coverage. Ni can be used instead of Cu but would not provide any significant improvement. Among the transition metals there are no candidates that provide a good Li nucleation at both low and high Li coverage. As such, it appears that Li nucleation at best would be similar to Cu, which is the currently used current collector and provides inadequate performance.

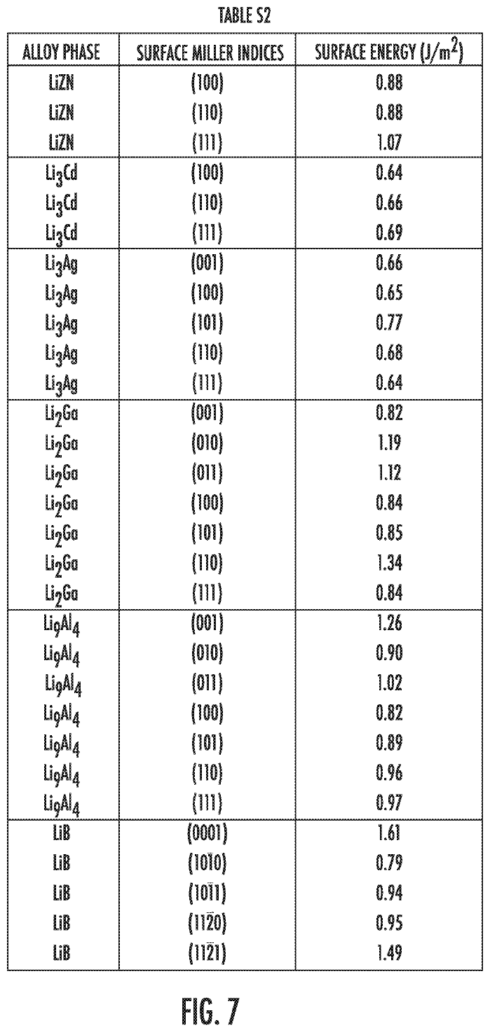

Of the Li-alloy surfaces, the Li-rich terminations are thermodynamically stable due to the fact that Li has the least surface energy compared to other elements. This means that on Li-alloy surfaces, the nucleation of Li effectively occurs on a strained Li surface. It is well known that the adsorption energy can be tuned depending on the strain of the surface. As such, the Li nucleation overpotentials for these Li-alloy surfaces are closer to Li than in the case of other transition metals considered above. The surface energies for the low miller index surfaces for these alloys are given in Table S2 (See FIG. 7, showing a list of surface energies for different Li alloy surfaces).

For LiZn, the (100) and (110) surfaces have the lowest surface energy. For Li₃Cd, the (100), (110) and (111) surfaces have comparable surface energies. For Li₃Ag, the (001), (100), (110) and (111) surfaces have similar surface energy while the (101) surface has a higher surface energy and would exist at a lower fraction on the surface. For Li₂Ga, the (001), (100), (101) and (111) surfaces will dominate the surface. For Li₉Al₄, the (010), (100), (101), (110) and (111) surfaces will exist on the surface of the alloys. Lastly for LiB, the (1010), (1011) and (1120) surfaces have low surface energies. As such, only these surfaces will be considered. As mentioned before, the surface energies of these stable surfaces are close to the surface energies of the Li surfaces (within

$$0.4 \frac{J}{{m}^{2}} ) ,$$

proving that the stable surfaces are Li-like.

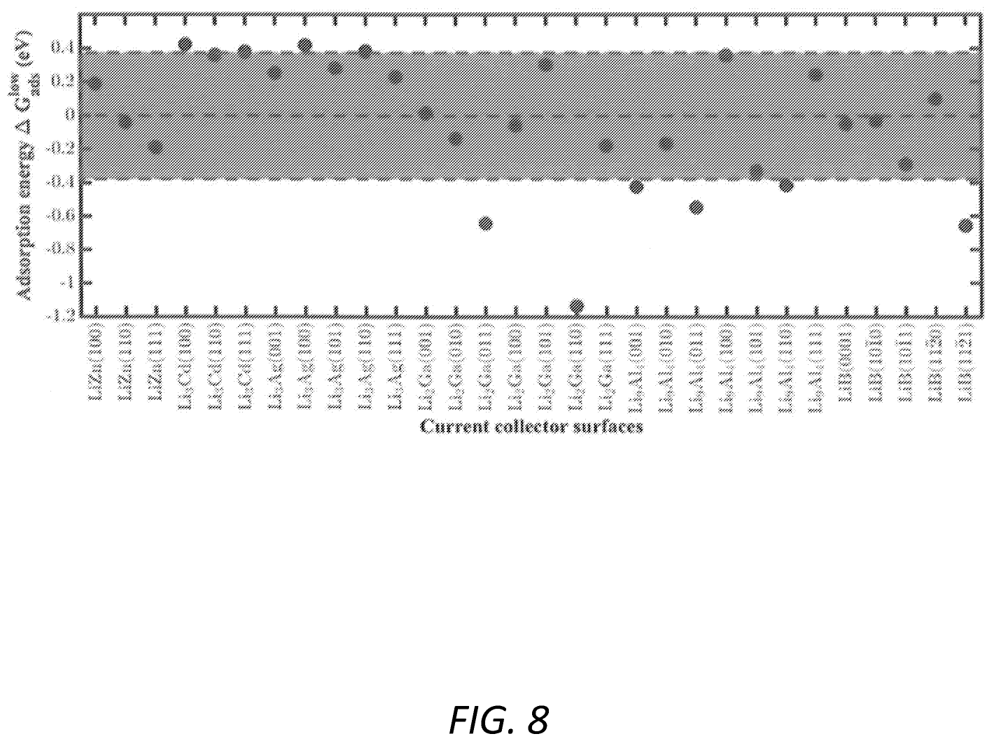

As shown in FIG. 8, for Li low coverage, Li₃Cd is slightly worse than Li. For Li₃Ag, the (100) and (110) surfaces are similar to Li while the (001) and (111) surfaces are significantly better. For Li₂Ga, the (101) surface is similar to Li, the (111) surface is slightly better, but the (001) and (100) surfaces have exceptionally low overpotentials. For Li₉Al₄, the (010) and (100) surfaces are similar to Li, the (011), (101) and (110) surfaces bind too strongly while the (111) surface is better than Li. Lastly for LiB, the (1120) surface has a non-existent overpotential, the (1010) surface is good and the (1011) surface is similar to Li.

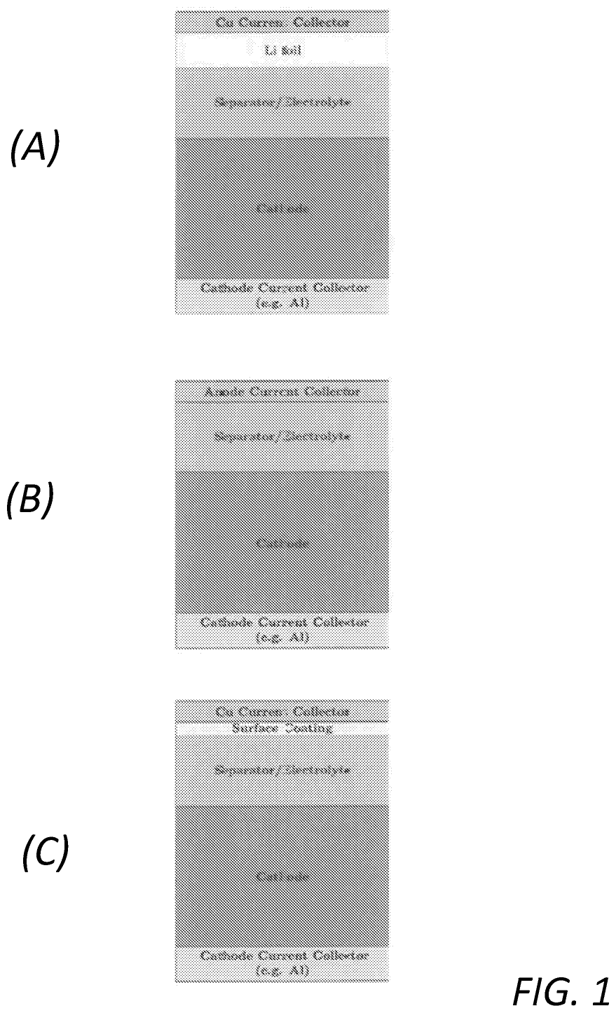

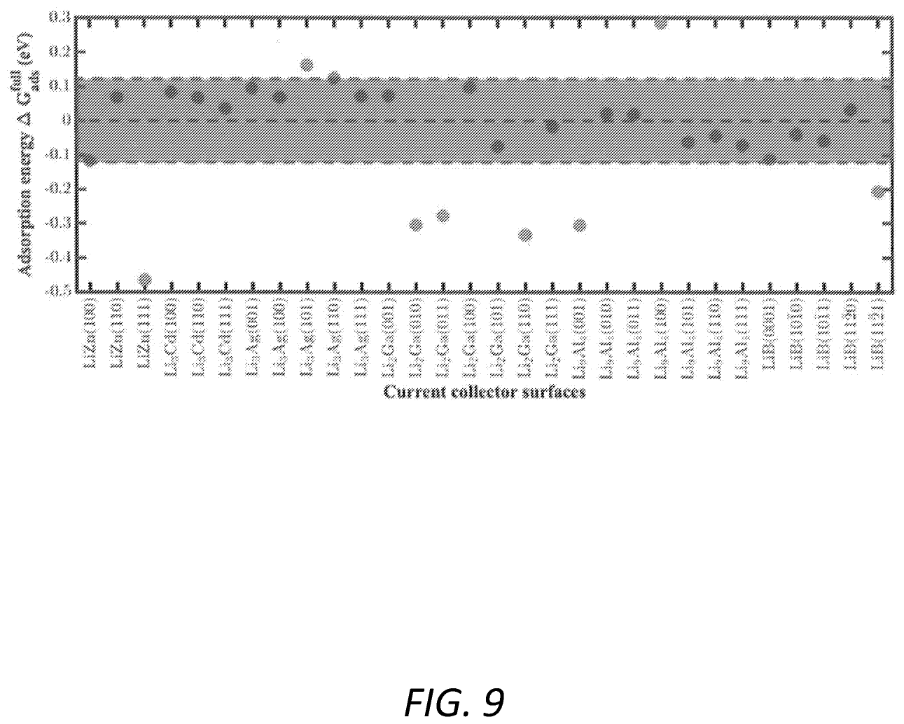

At 1 ML coverage for Li alloys, all the stable surfaces for all Li-alloys have a nucleation overpotential lower than 0.1 V, which is the case for Li(111) as can be seen in FIG. 9. The 1 ML Li adsorption energy decreases with the surface energy of the Li alloy surface and increases as the strain on the Li monolayer with reference to the bulk increases. This clearly proves that the more Li-like the Li alloy surface, the better the Li adsorption. Hence, considering nucleation overpotential losses, Li alloys in many of the cases provide almost no nucleation overpotentials when compared to the standard transition metal current collectors. Preferred embodiments of the invention will use materials having an adsorption energy for Li of between 0.1 eV and −0.1 eV as the composition of the current collector, in either of the configurations shown in FIGS. 1(B-C). In some embodiments, the preferred materials have adsorption energies within the shaded region of FIG. 9. In some embodiments, the preferred materials are Li-alloys, although the invention is not limited to the Li-alloys shown in FIG. 9 or otherwise discussed herein.

Ensuring 2-dimensional growth at high rates will depend on the surface diffusion of Li atoms on the current collector surface. Also, the faster the surface diffusion, the more likely the chance of uniform film growth, since the nucleation of Li on most of the current collector surfaces considered above is thermodynamically more favorable than nucleation on Li surfaces. During surface diffusion, the atoms jump from one site to the next site. The diffusion coefficient for such a process is given by:

$$D = {D}_{0} exp ( - \frac{{E}_{a}}{{k}_{B} T} )$$

To a first approximation, assume that the overall diffusion coefficient for Li diffusion on current collector surfaces is dependent on the activation energy. The Li surface diffusion activation energy was calculated using the nudged elastic band method for 12 surfaces on the low coverage cases and the results are shown in Table. 1. Two adjacent adsorption sites were considered as the initial and final states for the surface diffusion calculation. The nudged elastic band method as implemented in the atomic simulation environment was employed to create five intermediate states for Li diffusion.

TABLE 1
Activation Energies Calculated for a Set of
Transition Metals and Li Alloy Surfaces

| Surface | Activation Energy (Eₐ) |
|---|---|
| Li(100) | 0.08 |
| Li(110) | 0.01 |
| Li₂Ga(100) | 0.05 |
| Fe(100) | 0.14 |
| Cr(100) | 0.14 |
| V(100) | 0.13 |
| Mo(100) | 0.24 |
| Fe(111) | 0.26 |
| Cu(100) | 0.10 |
| LiZn(100) | 0.13 |
| Cu (111) | 0.03 |
| LiB(101̅0) | 0.07 |

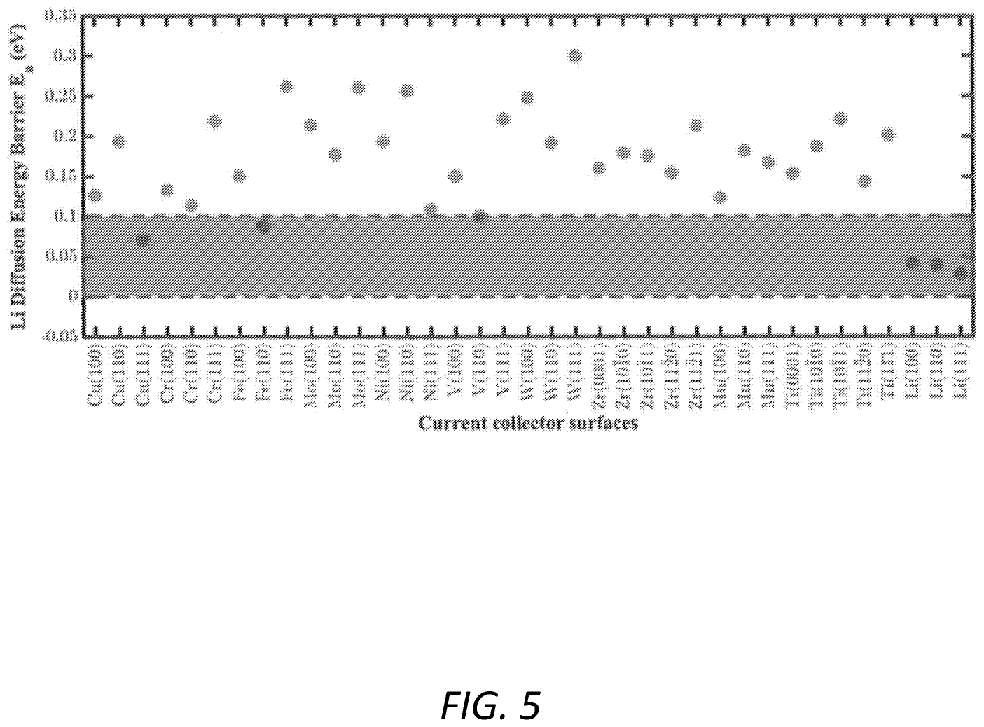

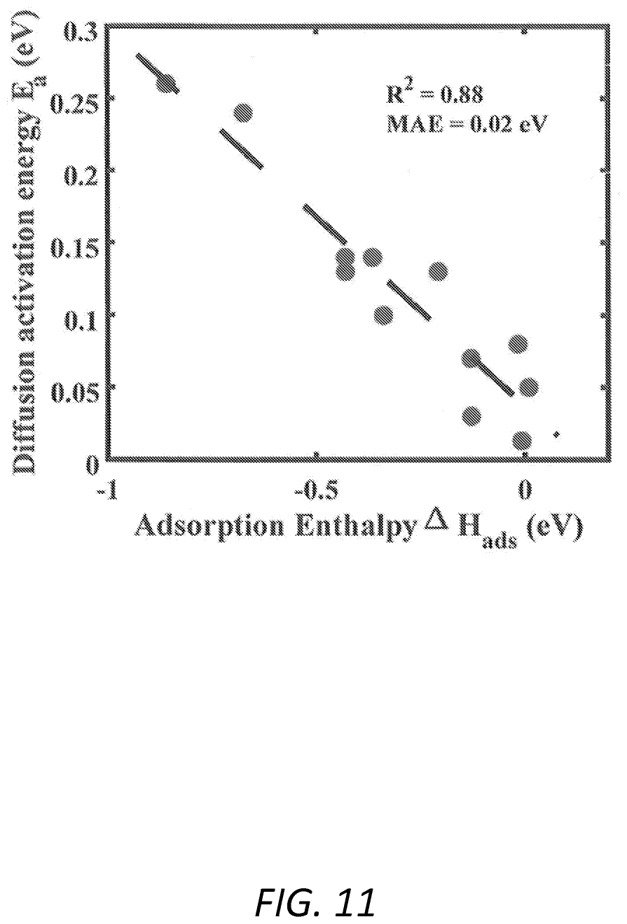

To calculate the Li-diffusion activation energies for all of the remaining surfaces, a Brønsted-Evans-Polanyi (BEP) relation between the activation energy and the adsorption enthalpy of 1 ML Li covered surfaces was derived. BEP relations have been demonstrated for a variety of adsorbates on different transition metal surfaces and provide a simple way to compute a large number of activation energies. As expected, there is a strong correlation between the activation energy and the adsorption enthalpy of the 1 ML covered Li surfaces, as shown in FIG. 11. An excellent BEP relation with a mean absolute error (MAE) of 0.02 eV was found on the training set of activation energies. This derived relationship can be used to determine the activation energy for all the remaining surfaces. As shown in Table 1, Li(110) has almost an ideal activation energy of 0.01 eV while Li(100) has a considerably larger value around 0.1 eV. Interestingly Cu(111) also has a very small barrier of about 0.03 eV. Considering Li(100) as a benchmark, materials that have an activation energy <0.15 eV are considered to be good candidates as current collectors. Among the transition metal surfaces, Cu(111) has the lowest surface diffusion barrier of 0.03 eV. Other than that Cu(100), Cr(100), Cr(110), Fe(100), Ni(111), V(100), V(110), Zr(1120), Mn(100), Ti(0001) and Ti(1120) as seen in FIG. 5, have sufficiently low activation energies. As previously discussed, out of these, Cu(111), Ni(111) and Ti(0001) are thermodynamically stable and are probable candidates. However, others may be used if grown epitaxially over other surfaces.

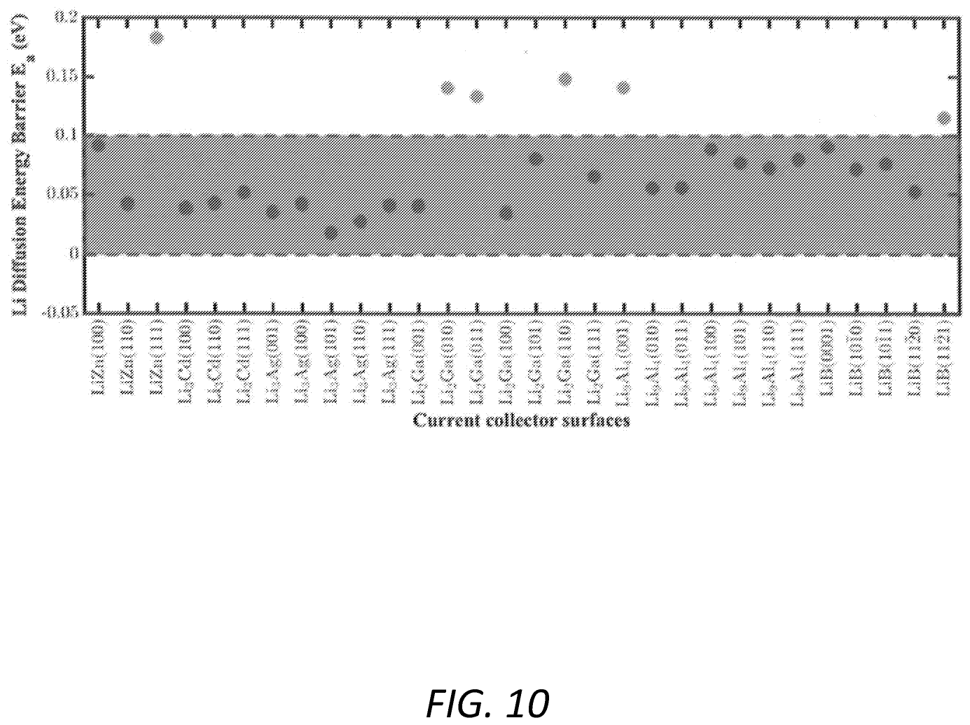

For all Li-alloy surfaces, except for LiZn(111), which is not thermodynamically stable, the activation energy is lower than the defined criteria of 0.15 eV as shown in FIG. 10. As such, Li-alloys are good for Li surface diffusion as well. Out of all the alloy candidates, Li₃Ag(101) surface has the lowest barrier of 0.02 eV, while Li₃Ag(110) has a barrier of 0.03 eV. Considering the surface energetics, all Li-alloys have average activation energies −0.05 eV. On average, most of the Li-alloys should be better than Cu. Preferred embodiments of the invention will use materials having a diffusion energy for Li of between 0 eV and 0.1 eV as the preferred composition for the current collector, in either of the configurations shown in FIGS. 1(B-C). In some embodiments, the preferred materials have diffusion energies within the shaded region of FIG. 10. In some embodiments, the preferred materials are Li-alloys, although the invention is not limited to the Li-alloys shown in FIG. 10 or otherwise discussed herein.

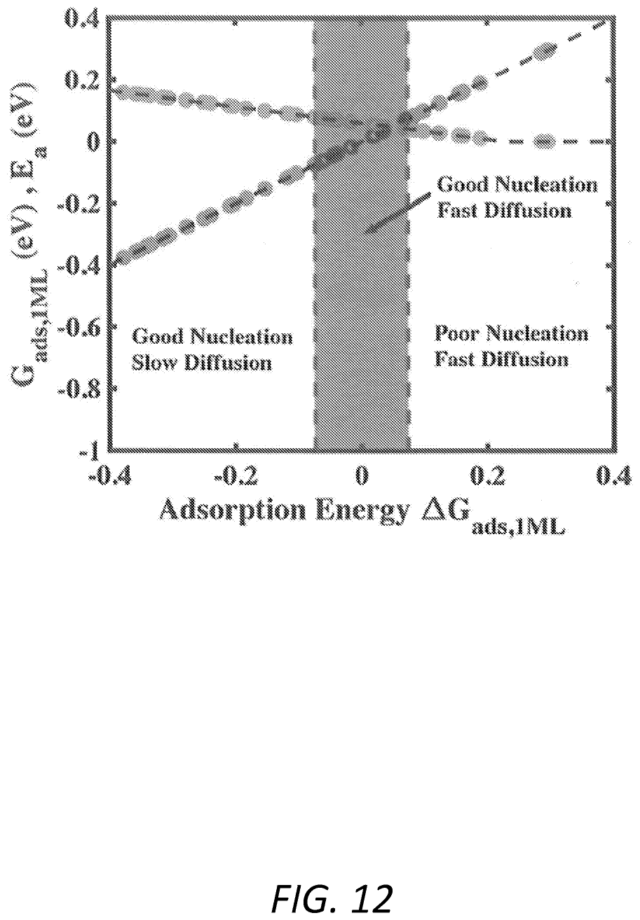

FIG. 12 shows that the 1 ML Li adsorption energy can be used as the descriptor for current collector performance. At low ΔG_{ads,1ML}. Li binds strongly resulting in good nucleation but poor diffusion. At high ΔG_{ads,1ML}, Li diffuses fast on the surface but does not nucleate. Thus, there is a small optimal range where the nucleation overpotential is less than that of Li(100), which will maximize performance.

Small diffusion activation energies, in addition to slightly stronger binding on the Li-alloy surfaces in comparison to Li, will also help in redistribution of the dendritic Li over time.

Lastly, it is well known in anode-free batteries that, at higher current rates, the Li nuclei size decreases and the nuclei number increases. This results in a tremendous increase in the surface area which results in significantly increased SEI formation reactions. Thus, a decrease in coulombic efficiency is expected with increase in higher charging current. As such, Li-alloys with better nucleation and diffusion will improve performance at high charging rates for anode-free cells.

In summary, candidates for potential current collectors for anode-free lithium metal cells were screened for a variety of properties. Using density functional theory calculations, the nucleation overpotentials and surface diffusion activation energies for Li on various current collector material surfaces have been calculated. Among the candidates considered, using Li and Li-alloys as the current collector it is possible to develop cells with specific energies greater than 400 Wh/kg, which is challenging with standard transition metal current collectors such Cu, Ni and Ti. NEB calculations were done to derive a BEP relation, which was then used to determine the Li surface diffusion activation energies. Using the BEP relation, to a first approximation, the 1 ML Li adsorption energy (ΔG_{ads,1ML}) can be used as a descriptor for current collector performance, with optimal performance obtained when ΔG_{ads,1ML}≈0. Li-alloys, Cu(111), Fe(110), V(110) and Ni(111) satisfy the above criterion. Thus, in accordance with the present invention, the use of Li-alloys such as Li—Zn, Li—Al, Li—B, Li—Cd, Li—Ag, Li—Si, Li—Pb, Li—Sn, Li—Mg etc. are suitable as current collectors for anode free batteries to get high specific energies, low nucleation overpotentials, better rate capability and probably better control over dendrite in good electrolytes.

We claim:

1. An anode-free lithium battery comprising:
a cathode having a cathode current collector,
an anode current collector; and
a layer of separator/electrolyte disposed between the cathode and the anode current collector;
wherein the anode current collector is a composition having a lithium adsorption energy between −0.1 eV and 0.1 eV.

2. The battery of claim 1 wherein the composition of the anode current collector is a lithium alloy or a lithium compound

3. The battery of claim 1 wherein the battery has a specific energy of 350 Wh/kg or greater.

4. An anode-free lithium battery comprising:
a cathode having a cathode current collector,
an anode current collector; and
a layer of separator/electrolyte disposed between the cathode and the anode current collector;
wherein the anode current collector is a composition having a lithium diffusion energy between 0 eV and 0.1 eV.

5. The battery of claim 4 wherein the composition of the anode current collector is a lithium alloy or a lithium compound.

6. The battery of claim 4 wherein the battery has a specific energy of 350 Wh/kg or greater.

7. An anode-free lithium battery comprising:
a cathode having a cathode current collector,
an anode current collector; and
a layer of separator/electrolyte disposed between the cathode and the anode current collector;
wherein the anode current collector is a layer of a transition metal having a surface layer of a composition having a lithium adsorption energy between −0.1 eV and 0.1 eV.

8. The battery of claim 7 wherein the transition metal is copper.

9. The battery of claim 8 wherein the composition of the surface layer is a lithium alloy or a lithium compound.

10. The battery of claim 7 wherein the battery has a specific energy of 350 Wh/kg or greater.

11. An anode-free lithium battery comprising:
a cathode having a cathode current collector,
an anode current collector; and
a layer of separator/electrolyte disposed between the cathode and the anode current collector;
wherein the anode current collector is a layer of a transition metal having a surface layer of a composition having a lithium diffusion energy between 0 eV and 0.1 eV.

12. The battery of claim 11 wherein the transition metal is copper.

13. The battery of claim 12 wherein the composition of the surface layer is a lithium alloy or a lithium compound.

14. The battery of claim 11 wherein the battery has a specific energy of 350 Wh/kg or greater.
